(19) United States
(12) Patent Application Publication
(10) Pub. No.: US 2012/0162626 A1
(43) Pub. Date: Jun. 28, 2012

(54) SHUTTER DEVICE FOR A LITHOGRAPHY APPARATUS AND LITHOGRAPHY APPARATUS

(75) Inventors: Marten Krebs, Auernheim (DE); Martin Rath, Adelmannsfelden (DE); Ulrich Beck, Aalen (DE)

(73) Assignee: CARL ZEISS SMT GMBH, Oberkochen (DE)

(21) Appl. No.: 13/329,536

(22) Filed: Dec. 19, 2011

Related U.S. Application Data
(60) Provisional application No. 61/425,905, filed on Dec. 22, 2010.

(30) Foreign Application Priority Data
Dec. 22, 2010 (DE) 10 2010 063 884.6

(51) Int. Cl. G03B 27/72

(52) U.S. Cl. 355/71

(57) ABSTRACT

A shutter device for a lithography apparatus includes a housing for maintaining an ultrahigh vacuum. A disk within the housing is rotatable about a rotation axis. The disk has at least one opening arranged on a circumferential line around the rotation axis and serving for transmitting ultraviolet light. A lithography apparatus includes such a shutter device, as well as a light source for ultraviolet light, an optical unit for imaging a pattern onto a target surface, and a camera device for detecting the imaged pattern.

### CROSS-REFERENCE TO RELATED APPLICATIONS

This application claims benefit under 35 USC 119(e) of U.S. Ser. No. 61/425,905, filed Dec. 22, 2010. This application also benefit under 35 U.S.C. §119 to German Application No. 10 2010 063 884.6, filed Dec. 22, 2010. The entire contents of both of these applications are hereby incorporated by reference.

### FIELD

The disclosure relates to a shutter device for a lithography apparatus and a lithography apparatus including such a shutter device.

### BACKGROUND

The industrial production of integrated electrical circuits and also other micro- or nanostructured components is generally achieved using lithographic methods. In such methods, a plurality of structured layers are applied to a suitable substrate, for example a semiconductor wafer. The layers are covered with a photoresist that is sensitive to radiation in a specific wavelength range. It is expedient to use light having a shortest possible wavelength for the exposure because the lateral resolution of the structures to be produced is directly dependent on the wavelength of the light. At the present time, it is common to use light or radiation in the deep ultraviolet (DUV) range or in the far, extreme ultraviolet (EUV) spectral range.

Customary light wavelengths for DUV systems are currently 248 nm, 193 nm and occasionally 157 nm. In order to obtain even higher lithographic resolutions, radiation through to soft X-ray radiation having a wavelength of a few nanometers is used and prototypes of optical systems are developed. For example, it is possible to provide a radiation source emitting light having a wavelength of 13.5 nm and corresponding optical units for lithographic purposes.

The wafer coated with photoresist is exposed by an exposure apparatus via a process in which a projection lens is used to image a pattern of structures on a mask or a reticle onto the photoresist. Because the EUV radiation is absorbed by matter to a great extent, reflective optical units and masks are increasingly being used.

After the photoresist has been developed, the wafer is subjected to chemical processes, so that the surface of the wafer is structured in accordance with the pattern on the mask. The residual photoresist that has not been processed is then rinsed away from the remaining parts of the layer. Further known methods for semiconductor production or processing, such as doping, etc., can follow. This process is repeated to form the semiconductor structure.

The performance of the lithographic apparatuses used is determined not only, for example, by the imaging properties of the projection lens but also, for example, by an illumination system that illuminates the mask. The illumination system usually contains light sources, which can include lasers operated in a pulsed fashion, or else plasma sources, and further optical elements, which generate light beams from the light generated by the light source, which converge on the mask or reticle at field points. It is often desirable to adjust and test the generation of the light beams and the resulting beam path in the respective lithographic apparatus prior to their use.

In order to test corresponding lithographic apparatuses, the individual functional units are usually examined. That is to say that, for example, the optical elements are measured with regard to their relative position, the position of the wafers are adjusted, and, in particular, the reticle or mask arrangements are examined microscopically. It is also desirable, however, to test the entire system or parts thereof prior to the actual start-up and the exposure of wafers with the original light for EUV lithography. Because EUV light sources, in general, cannot be switched off and switched on again in a cost effective fashion, controlled blocking of the light in the beam path within the lithography system is therefore desirable.

Known optical or photographic shutters include, for example, linearly extending slots which run at high speed past a window through which light can pass. Such slotted shutters can be constructed using a plurality of movable lamellae. Rotating crescent-shaped disks driven by an electric motor are also known. The high number of mechanical components or the vibrations that arise, for example, as a result of eccentric mounting of the movable components can be disadvantageous.

### SUMMARY

The disclosure provides an improved shutter device and a lithography apparatus improved thereby.

The lithography apparatus generally has a housing for maintaining an ultrahigh vacuum. A disk, capable of rotating about a rotation axis, is within the housing. The disk has at least one opening arranged on a circumferential line around the rotation axis. The opening transmits ultraviolet light.

The openings are designed in particular for transmission for extreme ultraviolet light. Extreme ultraviolet light (EUV) is generally understood to mean ultraviolet radiation in a spectral range of between 1 nm and 100 nm. In order to produce particularly fine nano- and microstructures lithographically, ultraviolet light or ultraviolet radiation at a wavelength of approximately 13.5 nm can be used. This is also referred to as EUV lithography.

Because EUV radiation is absorbed to a great extent in many materials, it is desirable to keep the beam path, that is to say the optical unit, masks, reticles, target surfaces such as wafers and the like, in a corresponding lithography apparatus, or in an EUV exposure apparatus under ultrahigh vacuum (UHV). A housing for a lithography apparatus or a shutter device can ensure, for example, a pressure of 10⁻⁷ to 10⁻¹² mbar (hPa). This is also referred to as a vacuum chamber. That means that only a molecular density of 10⁹ to 10⁴ molecules/cm³ is present in the beam path.

The disk, which can be embodied as a circular disk, for example, in this case preferably includes a plurality of openings on a circumferential line. During the rotation of the disk about the rotation axis and in the case of a ray or light beam of ultraviolet light that is incident substantially parallel to the rotation axis, the openings or holes in the disk release the ray. If a continuous EUV light ray is present, a pulsed radiation arises as a result, wherein the respective light pulse are dependent on the size of the openings and the rotational speed of the disk. Given pulsed radiation from the light source, either blocking of the radiation can be effected or the radiation pulses can be passed on in a controlled manner by suitable synchronization of the shutter times with the radiation pulse duration and frequency.

In the case of such an apparatus, reference can also be made to a rotational shutter or a rotating shutter disk as shutter device. This has the advantage over slotted shutter devices or rotating disks having an irregular contour that a particularly high rotational speed can be realized and particularly high pulse frequencies of up to 1 to 2 kHz, for example, can be achieved. Preferably, even pulse frequencies of up to 5 kHz are obtained. Preferably, this rotational speed is constant. Vibrations as a result of such a regular rotation or constant rotational speed are kept low as a result.

The disk preferably has a plurality of openings arranged on a common circumferential line of a circle around the rotation axis.

The disk can be embodied in circular fashion.

Given a circular embodiment and, in particular, regular arrangement of the openings on a common circumferential line, vibrations as a result of the rotation about the rotation axis can be kept low. By way of example, four openings can be provided in a manner respectively separated by a distance of 90° on a circumferential line. A different number of openings, such as six openings, for example, is also conceivable. Preferably, the openings are provided symmetrically with respect to the rotation axis. Preferably, the center of mass of the disk lies on the rotation axis.

In accordance with one embodiment of the shutter device, at least one opening has a larger extent along the circumferential line than an extent perpendicular to the circumferential line. The opening or openings can be embodied in the manner of an oval opening, for example.

In certain operating situations it is desired to synchronize the points in time at which light is transmitted by an opening with light pulses from a pulsed ultraviolet light source. If the pulsed light source has jitter the inaccuracy of the light pulse can be at least partly compensated for by a larger extent of the openings along the circumferential line.

In a further embodiment of the shutter device, a plurality of magnets are fitted to the disk along a further circumferential line. The further circumferential line can, for example, be at a greater distance from the rotational axis than the first circumferential line, on which the openings are arranged.

The magnets can preferably be encapsulated, such that no evaporations or contaminants can pass into the UHV region of the housing. The magnets can be arranged in pairs at opposite angular positions with respect to the circle center or the rotation axis. By way of example, neodymium magnets that are adhesively bonded onto the disk via suitable adhesives or are introduced into the material of the disk are suitable.

Preferably, the shutter device furthermore includes a magnet coil arrangement provided outside the housing and serving for interacting with the magnets on the disk.

By way of example, the magnets on the circumferential line on the disk in the ultrahigh vacuum with suitably fitted magnet coils outside the ultrahigh vacuum act as a type of linear motor along the circumferential line.

The shutter device has, in particular, no rotary leadthrough through the housing wall. Since magnet coils, in particular, can entail disturbing evaporations or contaminants, it is advantageous to embody the resulting electric motor composed of magnet coil arrangement and magnets on the disk in two parts. Rotor and stator are thus obtained in different regions of the shutter device or the lithography apparatus, namely firstly within the ultrahigh vacuum region and secondly outside the latter.

In one embodiment of the shutter device the magnets and the magnet coil arrangement form an electric motor suitable for rotating at a rotational speed of between 28,000 revolutions per minute and 29,000 revolutions per minute. Different rotational speeds are also conceivable. In this case, the number of openings in the rotational shutter disk can be adapted to the possible rotational speeds. A conceivable diameter for the disk is between 12 and 20 cm.

The combination of a specific number of openings and the rotational speed of the disk is preferably coordinated in such a way that pulse frequencies for radiation that has passed through the opening are between 100 Hz and 5 kHz. The pulse frequency results from the rotational speed divided by the number of openings on the circumferential line of the disk.

Appropriate material for the disk includes, by way of example, aluminum or beryllium, but also high-grade steel. The disk has, for example, a thickness of 2 to 10 mm and preferably a thickness of between 3.5 and 5.5 mm. In one embodiment of the shutter device, the disk can be mounted in the region of the rotation axis with the aid of a magnetic mount. In the case of a magnetic mount, in an advantageous manner, practically no abrasion is produced which might bring about contaminants in the ultrahigh vacuum region of the housing. On the other hand, mounts on the basis of ceramics are also conceivable.

The disk can also be mounted and driven exclusively by the interaction of the magnets with the coils, without a disk-carrying element having to be provided in the UHV region of the housing. For the case without energization of the corresponding magnetic bearing arrangement, it is possible to provide a depositing bearing, on which the disk can rest or run up.

In a further embodiment of the shutter device, the openings in the disk are formed with the aid of apertures. The apertures are then arranged on cutouts in the disk.

By virtue of the proposed shutter device with the aid of a rotational shutter within the ultrahigh vacuum region, the number of possible wearing parts is reduced compared with known measures for optical shutters. In this respect, the service lives of debris filters can be prolonged with the use of the proposed shutter device.

Furthermore, a lithography apparatus including a shutter device mentioned above is proposed, which includes a light source for ultraviolet light, in particular for extreme ultraviolet light, arranged within the housing, an optical unit for imaging a pattern onto a target surface, and a camera device for detecting the imaged pattern.

A lithography apparatus thus includes a housing for maintaining an ultrahigh vacuum, wherein a shutter device including a disk that is rotatable about a rotation axis is provided in the housing. The disk has at least one opening arranged on a circumferential line around the rotation axis and serving for transmitting extreme ultraviolet light. A light source for extreme ultraviolet light, an optical unit for imaging a pattern onto a target surface, and a camera device for detecting the imaged pattern are arranged within the housing.

In this case, the optical unit used can have a demagnifying imaging scale; by way of example, the optical unit can be embodied with an imaging scale of 1 to 4, and can be used for a microlithographic method.

The pattern to be imaged corresponds, for example, to a mask arrangement or a reticle for producing ultrafine micro- or nanostructures on semiconductor wafers as target surface. The camera device serves, for example, for testing the imaging performance of the (mirror) imaging optical unit. The lithography apparatus thus makes it possible to test the lithography apparatus with original light, for example 13.5 nm EUV. As a result, it is possible to test in particular masks or reticles in the lithography apparatus, without the need to scan the masks or reticles with the aid of microscopy. In this case the shutter device allows the generation of well-defined EUV pulses for detection by the camera.

Alternatively, the lithography apparatus can also be configured in such a way that a test optical unit is provided instead of an imaging optical unit which images the structures of the masks or reticles onto a wafer surface in a demagnified fashion. By way of example, a lithography test apparatus in which an optical unit creates a magnifying imaging scale can be formed. In this respect, in one embodiment of the lithography apparatus, the optical unit is a magnifying optical unit. This can then also be referred to as a mask test apparatus in which masks or reticles can be measured and examined with original exposure light with the aid of a camera provided.

The lithography apparatus can furthermore be equipped with a sensor device for detecting a movement of at least one opening of the disk and for generating a trigger signal. By way of example, a light barrier which detects the movement of the openings at a reference position is appropriate as a sensor device.

By way of example, the trigger signal can be used for activating or driving the light source.

Therefore, a control device for driving the light source in a manner dependent on the trigger signal is preferably provided.

In one embodiment of the lithography apparatus the control device is designed in such a way that the light source is activated in such a way that the openings transmit a predetermined number of light pulses from the light source during the rotation of the disk. It is possible, for example, to define an exposure window for the camera, such that, for example, 200 EUV pulses pass through the beam path of the lithography apparatus and are then detected by the camera.

Preferably, in one embodiment of the lithography apparatus, the disk is arranged in a beam path between the light source and a debris filter.

In a further embodiment of the lithography apparatus, the disk is arranged in such a way that the rotation axis has an angle with gravitational acceleration. The magnet coil arrangement then has a plurality of differently driven electromagnets for compensating for an effect of gravitational acceleration on the rotating disk. If the rotational axis is provided horizontally, for example, it may be desirable, in order to obtain as uniform as possible rotation and hence light pulse generation, for the magnet coils or electromagnets which are arranged above the rotation axis to be energized differently than those which are present below the rotation axis. The magnet coil units are provided in a manner situated opposite one another, for example.

Further possible implementations or variants of the shutter device or of the lithography apparatus also encompass combinations not explicitly mentioned of features described above or below with regard to the exemplary embodiments.

In this case, the person skilled in the art will also add individual aspects as an improvement or supplementations to the respective basic form.

Further configurations of the disclosure are described in the exemplary embodiments of the disclosure described below and in the claims.

### BRIEF DESCRIPTION OF THE DRAWINGS

The disclosure is explained in greater detail below on the basis of exemplary embodiments with reference to the accompanying figures, in which:

FIG. 1: shows a schematic illustration of an exemplary embodiment of a lithography apparatus;

FIG. 2: shows a schematic cross-sectional illustration of an exemplary embodiment of a shutter device;

FIG. 3: shows a schematic illustration in plan view of a first exemplary embodiment of a shutter disk;

FIG. 4: shows a perspective illustration in plan view of a second exemplary embodiment of a shutter disk; and

FIG. 5: shows an example of a signal diagram for possible exposure pulses.

### DETAILED DESCRIPTION

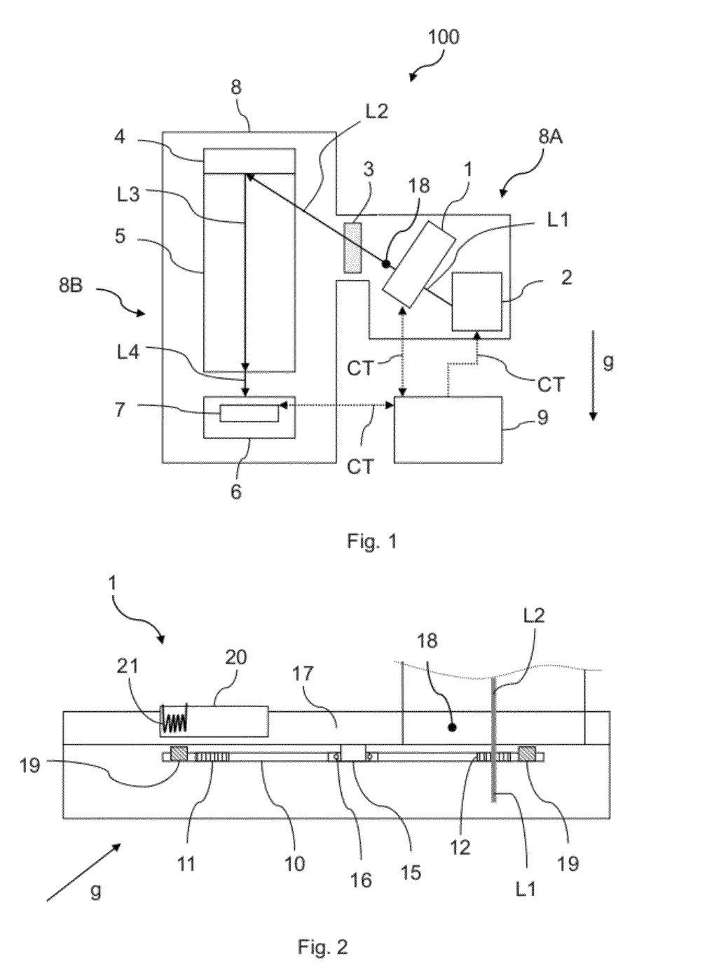

FIG. 1 shows a schematic illustration of an exemplary embodiment of a lithography apparatus. The lithography apparatus 100 is illustrated schematically in cross section. Since the lithography apparatus 100 is suitable for EUV lithography, in particular, the beam path is provided completely within a vacuum chamber. FIG. 1 firstly shows the vacuum chamber 8, or a housing embodied in a vacuum-tight fashion. In this case, the light generating device is provided in a housing part 8A on the right, in the orientation in FIG. 1 and the optical imaging system is provided in a second (left) housing part 8B.

The lithography apparatus 100 includes a radiation source 2 for generating EUV light. Gas-discharge-excited plasmas are appropriate as radiation sources. Xenon, for example, is deemed to be a suitable target material. Laser-excited plasmas as radiation sources for EUV light are also conceivable. Pulses of EUV light can be used. The EUV light has a wavelength of 13.5 nm, for example. In principle, it is possible to use a spectral range between ultraviolet and soft X-ray radiation with a wavelength of approximately 1 nm to 100 nm. Particularly efficient optical units can be produced for EUV radiation or EUV light around a wavelength of 13.5 nm.

The EUV light L1 generated by the radiation source 2 passes through a shutter device 1, which transmits the light in a pulsed fashion and thus provides EUV light L2 having a predetermined pulse frequency and pulse width. The light or radiation pulses L2 pass through a debris filter 3. The debris filter 3 serves for retaining particles of any form which can originate for example from electrode fragments, vaporized material or electrons, ions or atoms emitted by the plasma of the radiation source.

The left UHV chamber 8B includes a mask station 4, which contains the masks or reticles having the patterns to be imaged for photolithography. The EUV light L3 then passes through an optical system 5, which generally includes reflective optical units for EUV radiation. From the optical system 5, the light L4 passes onto a target surface, that is to say the surface to be processed of a semiconductor wafer. In FIG. 1, the wafer station is designated by 6.

In order to test for example the light source 2, the reticles 4 or the imaging performance of the optical unit 5, a camera 7 is provided instead of a wafer. Furthermore, a control device 9 which can be program-controlled, for example, is provided, which receives control and sensor signals from the camera 7, is communicatively coupled to the shutter device 1 and controls the radiation source 2. By way of example, the control device 9 can activate laser pulses for the plasma discharge. The control device 9 furthermore controls, for example, the shutter device 1 and radiation source 2 in such a way that well-defined EUV light pulses L2 are generated and can be detected by the camera 7 after passing through the optical unit 5.

During the exposure of coated semiconductor wafers, a generally demagnifying imaging of the mask or reticle structures in the mask station 4 is effected by the optical system 5. In a slightly modified embodiment of the lithography apparatus 100, expedient testing and measurement of the masks used in actual wafer production can be effected. In an implementation of the lithography apparatus as a measuring and test apparatus for a light source 2, a mask (station) 4 and/or optical elements used, an optical assembly 5 is used which creates a magnifying imaging of the mask structures toward the camera 7. In order to set a suitable exposure time for the camera 7, the shutter device 1, as indicated in the introduction, is driven correspondingly.

In the alternative configuration as a measuring and test apparatus, it is not necessary to image the entire mask structure onto the target surface in the region of the wafer station 6. It may suffice to use an optical unit 5 having a small field of view which images an excerpt from the mask respectively used, as it were microscopically, toward the camera 7.

It is furthermore indicated in FIG. 1 that gravitational acceleration points downward. The shutter device 1 is embodied with a rotating shutter disk in the UHV and transmits the light L2 at a predetermined reference position at a window 18 in the direction of the debris filter 3 and the mask arrangement 4.

FIG. 2 shows a schematic cross-sectional illustration of an exemplary embodiment of a shutter device. In this case, the shutter device 1 has two regions. A housing for maintaining an ultrahigh vacuum is provided, the ultrahigh vacuum being present below the housing wall 17 in the orientation in FIG. 2. A customary clean room atmosphere suffices above the housing wall 17 and outside the beam path for the EUV light. In the housing 17, that is to say within the UHV region, a shutter disk 10 is provided, which is mounted such that it is rotatable about a rotation axis 15 with the aid of a bearing 16. A magnetic bearing or a ceramic bearing can be used in order to reduce the number of wearing parts. Hybrid bearing embodiments are also possible.

In this case, the disk 10 has openings 11 for transmitting light L1. By way of example, EUV light from a light source, such as is indicated in FIG. 1, for example, is incident on the disk 10 from below parallel to the rotation axis 15. Provided that an opening 12 is not present at the location of the incident EUV light beam L1 in the region of the window 18.

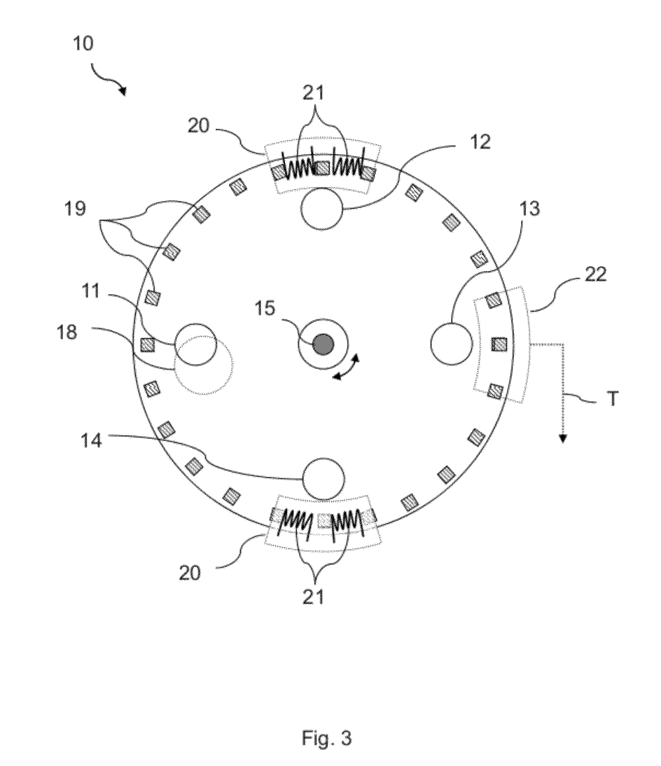

FIG. 3 illustrates a plan view of the exemplary embodiment of a shutter disk. The shutter disk is embodied as a circular disk 10 that is rotatable about the rotation axis 15. In order to drive the disk 10, magnets 19 are provided on a circumferential line along the edge of the shutter disk 10. The magnets 19 are, for example, neodymium magnets spaced apart at regular intervals on the circumference of the circular disk 10, in which case the magnets are preferably encapsulated in such a way that no evaporation or particles results contaminants in the UHV region. The magnets are introduced into the disk 10 for example as in FIG. 2, but can also be adhesively bonded thereto. A plastic sheathing of the magnets 19 is also conceivable, for example. The magnets 19 form a rotor of an electric motor, for example.

A magnet coil arrangement 20 is provided in the housing wall 17, as is illustrated in FIG. 2. The magnet coil arrangement 20 includes electromagnets 21 or energizable coils at predetermined positions (above the circular disk 10 in the orientation in FIG. 2). Two magnet coil arrangements 20 which are opposite each other with respect to the rotation axis 15 and which each include two coils 21 can be discerned in the plan view in FIG. 3.

Since, as already indicated with regard to FIG. 1, the circular disk 10 can be inclined on account of the installation situation, it is possible for the magnet coils 20 to be driven or energized differently. In FIG. 2, gravitational acceleration g is indicated by an arrow. Since the influence of gravitational acceleration and the weight of the disk can be manifested in particular at high rotational speeds of up to 30,000 revolutions per minute, compensation is possible by suitably driving the electromagnets 20.

The magnets 19 and the coils or electromagnets 21 together form an electric motor. An electric motor developed onto the circumference of the circular disk can be imagined. A linear electric motor arises, in principle, on the circumference of the circular disk along the magnets 19 provided in a manner spaced apart at regular intervals. Alternatively, the combination of magnets 19 and coil arrangement 20 can be embodied as a three-phase servomotor. The circular disk 10 can therefore be caused to rotate in a simple manner, as a result of which the openings 11 and 12, as illustrated in FIG. 2, or 11-14, as can be seen in FIG. 3, run on a circumferential line.

In FIG. 3, it can be discerned that the four openings 11-14 are provided in a manner respectively spaced apart at an angular distance of 90°. A circular disk having six openings, for example, which are provided in a manner spaced apart at angular distances of 60° is also conceivable. The shutter disk 10 transmits light in the direction of the optical system (cf. FIG. 1) only when the light ray L1 and one of the holes or openings 11-14 coincide. The light L1 impinges on the disk in the region of the window 18 and is either reflected or absorbed, unless one of the (aperture) openings 11-14 transmits the beam path.

During the operation of the shutter device 1 it is desirable to rotate the disk 10 in as constant a manner as possible at a high rotational speed. In order to synchronize the EUV light generation with the shutter times or transmission times for light of the shutter device 1, a sensor unit 22 is furthermore illustrated in FIG. 3. The sensor unit 22, which is provided for example as a light reflection transmitter or light barrier, generates a trigger signal T, if for example, an opening 13 passes the position of the sensor unit 22. Preferably, the sensor unit 22 is provided substantially opposite the location of the window 18 with respect to the rotation axis 15 where the light incidence and passage through the apertures or openings 11-14 take place.

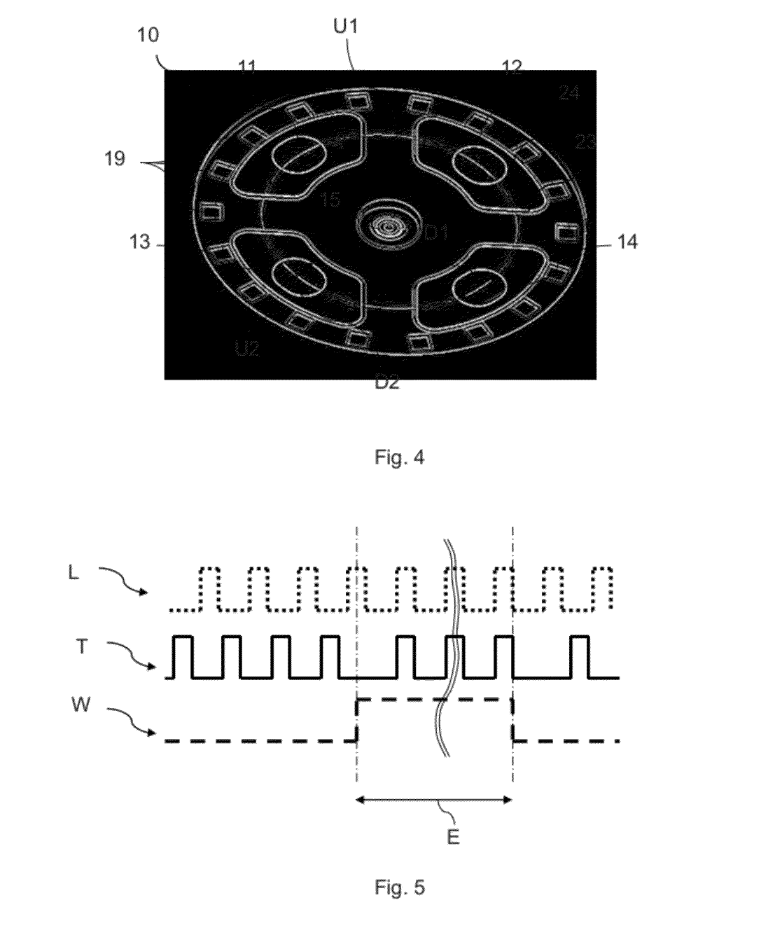

FIG. 4 shows a schematic illustration of a second exemplary embodiment of a shutter disk in a perspective illustration. The shutter disk 10 is again provided as a circular disk having a rotation axis 15. Magnets 19 are fitted on an outer circumferential line U2 in the vicinity of the edge of the disk 10. Four openings 11, 12, 13 and 14 are provided on an inner circumferential line U1. In this case, the openings 11, 12, 13 and 14 are not produced directly into the disk material by material removal, but rather with the aid of apertures 24. Therefore, segments 23 are cut out in the disk 10. The cutouts 23 are larger than the desired shutter openings 11, 12, 13 and 14, and the cutouts 23 are in turn covered by apertures 24. The apertures 24 in each case have the desired opening geometries and sizes for the transmission openings.

It is evident in FIG. 4 that the openings 11, 12, 13 and 14 have an extent D1 along the circumferential line U1 and an extent D2 perpendicular to the circumferential line U1. In the embodiment illustrated in FIG. 4, the extent D1 is greater than D2. In particular, the extent D1 along the circumferential line U1 determines the duration of a light pulse together with the rotational speed of the disk 10. By way of example, the openings are embodied in oval fashion. The embodiment of the shutter disk 10 with wide cutouts 23 and aperture (plates) 24 covering the latter enables a flexible setting of the opening sizes and geometries, without replacing the entire plate.

FIG. 5 shows examples of signal diagrams and possible exposure pulses. Time is plotted on the horizontal. The curve L shows the shutter state at the position of the exit window or the position of the light ray L1 (cf. FIGS. 1 and 2). It is evident that, with a frequency of 1900 Hz, for example, the shutter is open in each case for a predetermined pulse width. The middle curve T shows a trigger signal T, which activates the EUV source in such a way that in an exposure window (lower curve W), the EUV light passes via a predetermined number of pulses from the shutter device via the beam path L2, L3, L4, as indicated in FIG. 1, to the camera 7. The camera 7 receives EUV light, for example, over an exposure window or 200 pulses.

By way of example, the EUV source is operated with a pulse frequency of 1900 Hz. The combination of rotational speed and hole opening is likewise set such that the shutter opens at 1900 Hz. By setting and taking account of the trigger signal T, it is then possible to synchronize the pulse frequency of the EUV source or the light source and the opening frequency of the shutter with one another. This results in an exposure window E for the camera 7 in order to test for example the reticles, the imaging performance or radiation intensity at the target surface or the wafer station.

To avoid switching off the control source, after exposure has taken place in the exposure window E, the shutter and radiation source can be taken out of phase with regard to the rising edges in the signal diagrams, such that no EUV light passes through the EUV optical unit of the lithography apparatus and impinges on the camera. This can be discerned to the right and left of the exposure window E.

Although the present disclosure has been explained on the basis of exemplary embodiments, it is not restricted thereto, but rather can be modified in diverse ways. The proposed materials for the shutter disk should be understood merely by way of example. Moreover, different wavelengths can be used for the radiation. The pulse duration and pulse frequency of the EUV light can likewise be varied and adapted to the camera properties, for example. In addition, the number and geometry of the opening holes in the shutter disk can be modified in order to obtain the desired pulse lengths and frequencies.

Reference numbers and corresponding features:
1 Shutter device
2 EUV light source
3 Debris filter
4 Mask arrangement
5 Optical system
6 Wafer station
7 Camera
8 UHV cabinet
9 Control device
10 Shutter disk
11-14 Opening
15 Rotation axis
16 Bearing
17 Housing wall
18 Window
19 Magnet
20 Magnet coil arrangement
21 Coil
22 Light barrier
23 Cutout
24 Aperture
g Gravitational acceleration
L1-L4 Beam path
T Trigger signal
W Exposure window
E Exposure time
U1, U2 Circumferential line
D1, D2 Diameter
CT Control signal

What is claimed is:

1. A shutter device, comprising:
a disk configured to be arranged within a housing of a lithography apparatus, the housing being configured to maintain an ultrahigh vacuum, the disk having a rotation axis and an opening, the opening being arranged on a circumferential line around the rotation axis, the disk being rotatable about the rotation axis, and the opening being configured to transmit light during use of the system.

2. The shutter device of claim 1, wherein the disk has a plurality of openings arranged on the circumferential line.

3. The shutter device of claim 1, wherein the disk has four openings arranged on the circumferential line.

4. The shutter device of claim 1, wherein the disk has a plurality of openings arranged on the circumferential line around the rotation axis, and the circumferential line is in the shape of a circle.

5. The shutter device of claim 1, wherein the disk is circular.

6. The shutter device of claim 1, wherein the opening has a larger extent along the circumferential line than in a direction perpendicular to the circumferential line.

7. The shutter device of claim 1, further comprising a plurality of magnets fitted to the disk along another circumferential line.

8. The shutter device of claim 7, further comprising a magnet coil arrangement outside the housing, wherein the magnetic coil arrangement is configured to interact with the magnets.

9. The shutter device of claim 8, wherein the magnets and the magnet coil arrangement define an electric motor configured to rotate.

10. The shutter device of claim 1, further comprising a magnetic mount which mounts the disk in a region of the rotation axis.

11. The shutter device of claim 1, wherein the opening is defined by an aperture arranged on a cutout.

12. A system, comprising:
a lithography apparatus having a housing configured to maintain an ultrahigh vacuum; and
the shutter device of claim 1.

13. The system of claim 12, further comprising:
a light source within the housing;
an optical unit configured to image a pattern with light from the light source; and a camera device configured to detect the imaged pattern.

14. The system of claim 13, further comprising a sensor device configured to detect movement of the opening of the disk and configured to generate a trigger signal.

15. The system of claim 14, further comprising a control device configured to drive the light source based on the trigger signal.

16. The system of claim 15, wherein, during use of the system, the control device activates the light source so that the opening of the disk transmits a predetermined number of light pulses from the light source when the disk rotates.

17. The system of claim 12, further comprising a debris filter, wherein the disk is arranged in a light beam path between the light source and the debris filter.

18. The system of claim 12, wherein:
the disk is arranged so that the rotation axis has an angle relative to a gravitational force; and
the shutter device comprises a magnet coil arrangement comprising a plurality of differently driven electromagnets configured to compensate for an effect of gravitational acceleration on the rotating disk.

19. The system of claim 1, further comprising:
a plurality of magnets fitted to the disk along another circumferential line; and
a magnet coil arrangement configured to interact with the magnets,
wherein the plurality of magnets is inside the housing, and the magnet coil arrangement is outside the housing.

20. A shutter device, comprising:
an optical element configured to be arranged within a housing of an optical apparatus, the housing being configured to maintain ultrahigh vacuum, and the optical element being rotatable about a rotation axis.

21. The shutter device of claim 21, wherein the rotatable element comprises an element capable of deflecting ultraviolet light.

22. The shutter device of claim 21, wherein the rotatable optical element comprises an element capable of refracting ultraviolet light.

23. A system, comprising:
an optical apparatus having a housing configured to maintaining an ultrahigh vacuum; and
an optical element within the housing, the optical element being rotatable about a rotation axis.

24. The system of claim 23, further comprising a rotatable structural element, wherein the optical element is arranged on the rotatable structural element.

25. The system of claim 23, further comprising a disk, wherein the optical element is arranged on the disk.

26. The system of claim 25, further comprising a plurality of magnets fitted to the disk, wherein the plurality of magnets is arranged along a circumferential line.

27. The system of claim 26, further comprising a magnet coil arrangement outside the housing, wherein the magnetic coil arrangement is configured to interact with the plurality of magnets.

28. The system of claim 24, wherein the rotatable structural element is part of an electric motor.

29. The system of claim 22, wherein the optical element comprises at least one element selected from the group consisting of a refractive element, a reflective element, a slot, and a shutter opening.
